(19) United States
(12) Patent Application Publication
(10) Pub. No.: US 2013/0094490 A1
(43) Pub. Date: Apr. 18, 2013

(54) WIRELESS COMMUNICATION APPARATUS

(71) Applicants: Makoto TAROMARU, Fukuoka-shi (JP); Takahiko KISHI, Tokyo (JP); Eiji NIWA, Tokyo (JP)

(72) Inventors: Makoto TAROMARU, Fukuoka-shi (JP); Takahiko KISHI, Tokyo (JP); Eiji NIWA, Tokyo (JP)

(73) Assignees: TOYOTA INFOTECHNOLOGY CENTER CO., LTD., Tokyo (JP); FUKUOKA UNIVERSITY, Fukuoka-shi (JP); TOYOTA JIDOSHA KABUSHIKI KAISHA, Toyota-shi (JP)

(21) Appl. No.: 13/589,868

(22) Filed: Aug. 20, 2012

(30) Foreign Application Priority Data
Oct. 13, 2011 (JP) 2011-226208

(51) Int. Cl. H04J 1/00

(52) U.S. Cl. 370/343

(57) ABSTRACT

A wireless communication apparatus has a first communication unit configured to perform at least one of transmission and reception by using a multicarrier signal constituted by a plurality of subcarriers shaped by a band-limited pulse waveform; and second communication unit configured to perform at least one of transmission and reception by using a signal having a different modulation format or modulation constant from said signal of said first communication unit. Said first communication unit configured to perform communication without using at least one of said plurality of subcarriers, and said second communication unit configured to perform communication using a band of said subcarrier not used by said first communication unit.

### BACKGROUND OF THE INVENTION

1. Field of the Invention

The present invention relates to a wireless communication apparatus.

2. Description of the Related Art

Recent years have witnessed the popularization of comparatively close range wireless communication systems such as wireless LANs and increases in transmission speeds. An increase in transmission speed typically leads to deterioration of a transmission characteristic due to the effect of a delay spread occurring during multipath propagation. In response to this problem, multicarrier transmission through OFDM (Orthogonal Frequency Division Multiplexing) is used in wireless LANs and digital terrestrial television broadcasting. Multicarrier transmission is frequency multiplexed transmission using a plurality of modulated subcarriers, wherein a modulation signal is generated by inverse fast Fourier transform (IFFT). Further, all symbols are synchronized so that all of the subcarriers are modulated at an identical symbol rate.

In an OFDM transmission signal, a section known as a guard interval (GI) is attached to a leading part of a modulation symbol. A copy of a trailing edge part of a transmission symbol waveform is disposed in this section, and therefore the section is also known as a cyclic prefix (CP). As long as the multipath delay spread is no greater than a length of the GI, it is possible to compensate for delay distortion, but when the delay spread exceeds the GI length, an error occurring during data demodulation increases, leading to characteristic deterioration. By increasing the GI length, a favorable error rate characteristic can be obtained even when the delay spread is large, but in this case, an OFDM symbol length increases, leading to a reduction in a data rate. It is therefore typical in OFDM to design a communication system that uses a required minimum GI length corresponding to an envisaged delay spread on a propagation path (a transmission path), or in other words an impulse response length of a transmission path characteristic. The GI length is normally fixed, and in a multiple access communication system constituted by a master station (base station) device and a slave station (terminal) device, a common value is used for all terminals. In a communication system using time division multiple access, the GI may be switched over time for each time slot, but with TDMA, different problems arise in that a modulation speed, or in other words a symbol clock, increases and a transmission delay increases in proportion with a TDMA frame length. Hence, Using TDMA to vary the GI length is not typically used.

Further, the respective subcarriers in OFDM have mutually overlapping spectra, and therefore, even when an amplitude of a specific subcarrier is set at zero, the spectrum of an adjacent or next-but-one subcarrier overlaps a frequency of the specific subcarrier. Hence, when other comparatively narrowband wireless communication exists at a certain frequency, it is difficult to avoid interference even by setting the amplitude of the subcarrier corresponding to the certain frequency at zero. To solve this problem, Japanese Patent Application Publication No. 2005-236364 and “Feasibility Investigation of Gaussian Multicarrier Transmitter via FPGA Implementation”, (OHORI Tetsuou, ONODERA Junichi, GOTO Kenji, TERAO Tsuyoshi, SUYAMA Satoshi, SUZUKI Hiroshi), Technical Report of IEICE, RCS2007-220, pp. 205-210 propose a multicarrier transmission system in which subcarriers are band-limited by a Gaussian function, and disclose experiment results and so on. By shaping a transmission waveform using a Gaussian function, a sharp spectral attenuation characteristic can be provided, and as a result, inter-symbol interference and inter-subcarrier interference in the system itself as well as radio interference with another system can be suppressed.

In a conventional technique, for example OFDM frequency division multiple access (OFDMA) such as WiMAX (IEEE802.16 standard), all of the subcarriers are modulated and demodulated at once using FFT and IFFT (fast Fourier transform and inverse fast Fourier transform). Therefore, the GI length cannot be set at a different value in relation to a specific subcarrier. Hence, the GI length must be designed in accordance with a maximum delay spread such that an excessive GI is used in relation to a slave station on a propagation path having a small delay spread, and as a result, frequency resources are wasted needlessly.

Two different modulating-demodulating means may be provided to vary the GI length, symbol rate, and so on for each subcarrier. More specifically, the master station device may include, in addition to modulating-demodulating means for performing OFDM modulation and demodulation, separate, independent modulating-demodulating means having different modulation constants such as the GI and the symbol rate or using a completely different modulation format. However, the spectra of signals generated by the respective modulating-demodulating means overlap each other while having different GIs, and therefore the signals do not have a mutually orthogonal relationship. Accordingly, interference occurs between the signals, leading to a large increase in a bit error rate, and this system cannot therefore be put to practical use.

An in-vehicle wireless communication system may be cited as an environment in which subcarriers require different GIs. In recent years, communication between in-vehicle devices via wireless connections has increased relative to communication via wired connections. Various environments exist in a vehicle interior, and in an engine room, a periphery of which is surrounded by metal, radio wave reflection is more likely to occur, leading to an increase in the delay spread. It is therefore necessary to increase the GI for communication between in-vehicle devices disposed in the engine room. Further, since the in-vehicle devices disposed in the engine room are shielded from in-vehicle devices disposed in a passenger compartment by metal, direct waves do not exist and the delay spread is large. Therefore, a large GI is required for communication between the in-vehicle devices disposed in the engine room and the in-vehicle devices disposed in the passenger compartment, similarly to the engine room. On the other hand, the delay spread of a propagation path between the in-vehicle devices disposed in the passenger compartment is not so large, and therefore the GI can be reduced.

Furthermore, a slave station that performs OFDMA has a complicated configuration due to the need for OFDM modulation and demodulation. It is therefore difficult to apply OFDMA to a slave station device such as a small sensor terminal that is capable of implementing only single carrier low speed transmission. For example, a sensor node installed in a vehicle is often required to be small and inexpensive, making it difficult to provide an OFDM modulator-demodulator therein.

Moreover, OFDM subcarriers have an occupied bandwidth that is several times larger than a subcarrier interval, and therefore, when other comparatively narrowband wireless communication exists at a specific frequency, interference cannot be avoided even by setting the amplitude of the subcarrier corresponding to the specific frequency at zero, for example. It is therefore necessary to allocate the subcarrier to a frequency that is sufficiently removed from the frequency used by the other wireless system. For these reasons, it is difficult to operate the conventional communication system described above in an ISM (Industrial, Scientific, and Medical) band such as a 2.4 GHz band in which various wireless systems coexist.

### SUMMARY OF THE INVENTION

The present invention has been designed in consideration of the problems described above, and provides a wireless communication apparatus with which, during communication with communication terminals existing in different radio wave propagation environments, a modulation system and a modulation constant most suited to the propagation environment of each terminal can be set.

With a wireless communication apparatus according to a first embodiment of the present invention, during communication with communication terminals existing in different radio wave propagation environments, the modulation system and modulation constant most suited to the propagation environment of each terminal can be set using following means.

In one aspect of the invention, a wireless communication apparatus comprises: first communication unit configured to perform at least one of transmission and reception by using a multicarrier signal constituted by a plurality of subcarriers shaped by a band-limited pulse waveform; and second communication unit configured to perform at least one of transmission and reception by using a signal having a different modulation format or modulation constant from said signal of said first communication unit, wherein said first communication unit configured to perform communication without using at least one of said plurality of subcarriers, and said second communication unit configured to perform communication using a band of said subcarrier not used by said first communication unit.

By shaping the transmission waveform using a band-limited pulse waveform, a steep spectral attenuation characteristic can be obtained. In other words, a spectral dip can be formed deeply, with the result that inter-carrier interference can be reduced. Therefore, by creating a subcarrier (a null carrier) not used for communication, other communication can be performed using the null carrier band. Communication in this band does not interfere with multicarrier communication, and therefore the modulation format and modulation constant can be set freely in accordance with the functions of each terminal, the envisaged delay spread of the transmission path, and so on. As a result, this communication can be accommodated simultaneously with multicarrier communication through FDMA.

A symbol of said subcarrier used by said first communication unit can be non-synchronous with a symbol of a carrier used by said second communication unit.

By shaping the transmission waveform using a band-limited pulse waveform, inter-subcarrier interference can be minimized. In other words, communication can be performed even when a signal modulated by the first communication unit and a signal modulated by the second communication unit are not orthogonal, and therefore the respective symbols can be made non-synchronous.

Said first communication unit can be configured to perform communication without using at least two of said plurality of subcarriers, and said second communication unit can be configured to communicate identical signals infrequency bands of said subcarriers not used for communication by said first communication unit, and said second communication unit can be either configured to transmit said signals in said respective frequency bands after weighting said signals or configured to select and transmit a signal in any of said frequency bands.

With this configuration, a plurality of carriers modulated by identical data can be transmitted, and therefore a frequency diversity effect to cope with frequency selective fading can be obtained. Further, the apparatus can be operated using a single transmission antenna, enabling a reduction in the size of the apparatus.

Said second communication unit can be configured to transmit said signals in said plurality of frequency bands after weighting said signals such that said signals in said plurality of frequency bands have an identical phase in an antenna input of a transmission destination terminal, and Said second communication unit can be configured to transmit said signals in three frequency bands fc+fd, fc, fc−fd having equal frequency intervals.

By making the intervals between the plurality of transmission frequencies equal such that the signals are transmitted at an identical phase, the transmission destination terminals can demodulate the received signals without the need for complicated calculations.

Said first communication unit can be configured to perform communication without using at least two of said plurality of subcarriers, and said second communication unit can be configured to perform transmission to a plurality of terminals by using transmission signals in frequency bands of said subcarriers not used for communication by said first communication unit, and said transmission signals of said respective frequency bands can be determined by subjecting data addressed to a plurality of terminals to weighted synthesis on the basis of a propagation path characteristic, and Said second communication unit can be configured to transmit said data addressed to said plurality of terminals after weighting said data such that said data are received dominantly in antenna inputs of said terminals.

With this configuration, spatial multiplexing transmission can be performed using a single transmission antenna, leading to an improvement in a frequency usage efficiency. Further, the transmission destination terminals do not have to perform signal separation processing, and therefore the apparatus can be simplified.

Said first communication unit can be configured to perform communication without using at least two of said plurality of subcarriers, said second communication unit can be configured to receive signals by using frequency bands of said subcarriers not used for communication by said first communication unit, signals including identical data can be transmitted from a transmission source in said respective frequency bands, and said second communication unit can be either configured to receive said signals in said respective frequency bands after weighting said signals or configured to select and transmit a signal in any of said frequency bands.

With this configuration, a frequency diversity effect generated when identical signals are transmitted at a plurality of frequencies can be obtained likewise during reception.

Said first communication unit can be configured to perform communication without using at least two of said plurality of subcarriers, said second communication unit can be configured to receive signals from a plurality of terminals by using frequency bands of said subcarriers not used for communication by said first communication unit, said plurality of terminals can be respectively transmitted signals in a plurality of frequency bands, and said signals transmitted from said respective terminals can be extracted by subjecting said signals received in said respective frequency bands to weighted synthesis on the basis of a propagation path characteristic.

With this configuration, an improvement in the frequency usage efficiency achieved through spatial multiplexing transmission can be obtained likewise during reception.

In other aspect of the invention, a wireless communication apparatus comprises: reception unit configured to receive signals in a plurality of frequency bands, transmitted from said second communication unit of the wireless communication apparatus according to claim 3; and frequency conversion unit configured to frequency-convert an input signal, wherein said signals in said plurality of frequency bands received by said reception unit are converted into a common frequency band by said frequency conversion unit.

With this configuration, signals transmitted at a plurality of frequencies can be received using reception unit configured to receive a single frequency, and therefore the apparatus configuration can be simplified.

In other aspect of the invention, a wireless communication apparatus comprises: reception unit configured to receive signals in frequency bands fc+fd, fc, fc−fd, transmitted from said second communication unit of the wireless communication apparatus according to claim 5; and frequency conversion unit configured to frequency-convert an input signal and outputting a signal obtained by superposing said input signal, a signal obtained by frequency-converting said input signal by a frequency+fd, and a signal obtained by frequency-converting said input signal by a frequency−fd, wherein said reception unit configured to superpose and adds said signals in said frequency bands fc+fd, fc, fc−fd to said frequency band fc by unit of said frequency conversion unit.

With this configuration, signals can be received from a plurality of frequency bands using a simple configuration obtained by adding the frequency conversion unit to a normal single carrier transmission/reception circuit.

According to the present invention, it is possible to provide a wireless communication apparatus with which, during communication with communication terminals existing in different radio wave propagation environments, the modulation system and modulation constant most suited to the propagation environment of each terminal can be set.

### BRIEF DESCRIPTION OF THE DRAWINGS

FIG. 1 is a functional block diagram showing a wireless communication apparatus according to the present invention;

FIG. 2 is a view illustrating a subcarrier shaped by a Gaussian pulse;

FIG. 3 is a view illustrating a method of shaping the subcarrier using the Gaussian pulse;

FIG. 4 is a diagram in which a separate carrier and a separate symbol have been disposed in a null carrier of multicarrier communication;

FIG. 5 is a view illustrating a configuration of a multicarrier modulation signal generation unit according to a first embodiment;

FIG. 6 is a view illustrating a configuration of a single carrier modulation signal generation unit according to the first embodiment;

FIG. 7 is a view illustrating a configuration of a multicarrier demodulation unit according to the first embodiment;

FIG. 8 is a view illustrating a configuration of a single carrier terminal according to the first embodiment; and

FIG. 9 is a view illustrating a terminal configuration of a wireless communication system according to a second embodiment.

### DESCRIPTION OF THE PREFERRED EMBODIMENTS

### First Embodiment

[System Configuration]

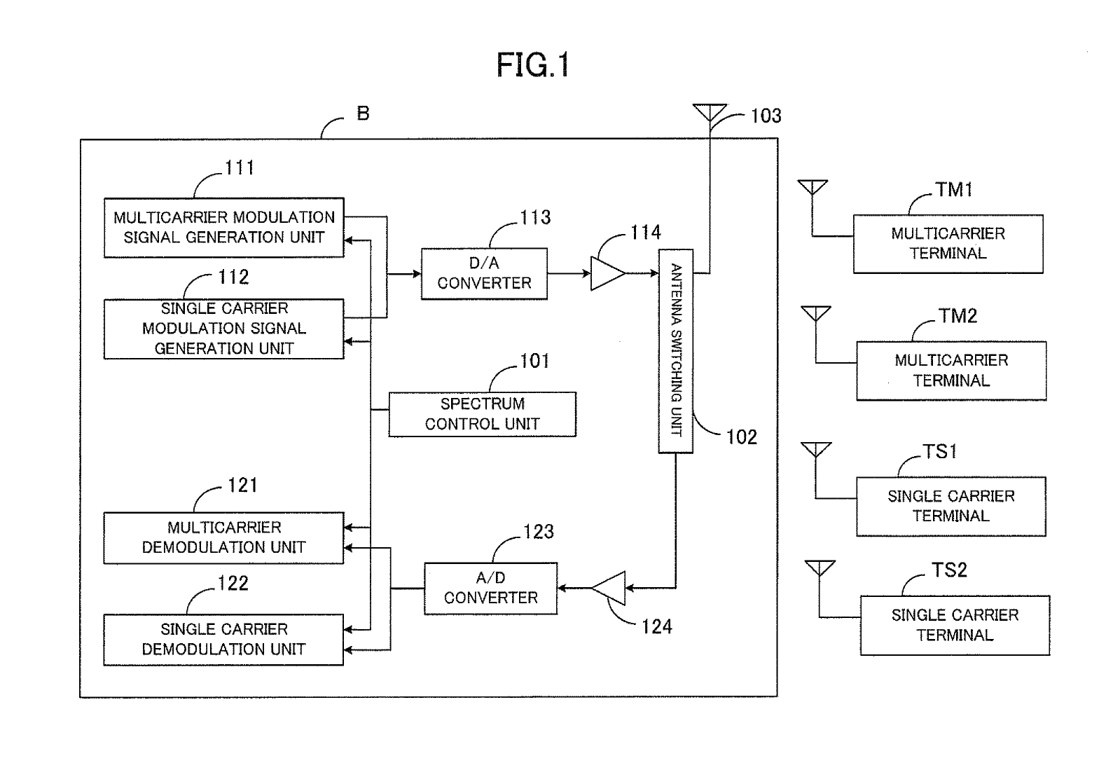

FIG. 1 is a view illustrating a system configuration of a wireless communication system.

This system is used to perform wireless transmission between a master station device such as a base station, an access point, a host, or a sink node and a slave station such as a terminal, a client, or a sensor node in a comparatively short range space such as a room interior, a vehicle interior, or an apparatus interior. The master station device performs multiple access with a plurality of slave stations.

The system is constituted by a master station device B, and a multicarrier terminal TM and a single carrier terminal TS serving as slave station devices. Here, a case in which the master station device B communicates with two multicarrier terminals TM1, TM2 and two single carrier terminals TS1, TS2 will be described as an example, but there are no limitations on the number of slave station devices. A multicarrier terminal has a higher transmission speed than a single carrier terminal. A single carrier terminal has a low transmission speed but a simple configuration and low power consumption. Therefore, a single carrier terminal is favorable in an embodiment such as a sensor terminal or the like that is small and requires a small amount of power in a case where a power supply is limited, for example.

During communication between the master station device and the multicarrier terminals according to this embodiment, multicarrier communication is performed without using one or a plurality of subcarriers from among the subcarriers that can be used for multicarrier communication. During communication between the master station device and the single carrier terminals, single carrier communication is performed using a frequency of a subcarrier that is not used for multicarrier communication.

A system configuration of the master station device B will now be described.

The master station device B according to the first embodiment includes a multicarrier modulation signal generation unit 111, a single carrier modulation signal generation unit 112, a D/A converter 113, and an amplifier 114, wherein these units together constitute transmission unit. The master station device B also includes a multicarrier demodulation unit 121, a single carrier demodulation unit 122, an A/D converter 123, and an amplifier 124, wherein these units together constitute reception unit. The master station device B further includes a spectrum control unit 101, an antenna switching unit 102, and an antenna 103, which are common to the transmission unit and the reception unit.

Respective configurations will now be described. The multicarrier modulation signal generation unit 111 is unit for converting an input transmission subject digital signal sequence into a modulation signal having a plurality of carriers. More specifically, transmission data are subjected to parallel conversion, primary modulation is performed on the respective data, a plurality of subcarrier signals are generated by inverse Fourier transform (IFFT), the generated subcarrier signals are subjected to band limitation through waveform shaping using a Gaussian pulse, and then the signals are synthesized. Band limitation through waveform shaping using a Gaussian pulse and the multicarrier modulation signal generation unit 111 will be described in detail below. In this embodiment, multiple access through OFDMA is envisaged, but multiple access may be realized using TDMA or FDMA.

The single carrier modulation signal generation unit 112 is unit for converting an input transmission subject digital signal sequence into a modulation signal having a single carrier. More specifically, transmission data are subjected to primary modulation, whereupon band limitation is implemented through waveform shaping using a Gaussian pulse. In this embodiment, identical transmission data are transmitted at a plurality of different frequencies to obtain a frequency diversity effect. The single carrier modulation signal generation unit 112 will be described in detail below. In this embodiment, QAM (Quadrature Amplitude Modulation) or QPSK (Quadriphase Phase-Shift Keying) is envisaged as a primary modulation system, but another modulation system may be used.

The modulation signal generated by the multicarrier modulation signal generation unit 111 and the modulation signal generated by the single carrier modulation signal generation unit 112 are synthesized and input into the D/A converter 113. A signal generation method and specific signal content will be described below.

The D/A converter 113 is unit for converting a generated digital signal sequence serving as a base band signal into a radio frequency signal. The amplifier 114 is a power amplifier for amplifying the converted radio frequency signal. A band pass filter may be provided between the D/A converter 113 and the amplifier 114.

The antenna switching unit 102 is a switch for electrically separating a transmission path from a reception path so that the antenna 103 can be used for both transmission and reception. The antenna switching unit 102 is realized by connecting a transmission filter having a reception frequency as a stop band and a reception filter having a transmission frequency as a stop band via a phase shifter.

The A/D converter 123 is unit for converting the radio frequency signal into a digital signal sequence. Further, the amplifier 124 is a low noise amplifier for amplifying the radio frequency signal input into the A/D converter 123.

The multicarrier demodulation unit 121 is unit for demodulating the multicarrier modulation signal into a digital signal sequence serving as a base band signal. Further, the single carrier demodulation unit 122 is unit for demodulating the input single carrier modulation signal into a digital signal sequence serving as a base band signal.

The spectrum control unit 101 is unit for determining frequencies, or in other words a spectrum, to be used to communicate with the respective terminals. An operation of the spectrum control unit 101 will be described in detail below.

[Waveform Shaping Using Gaussian Pulse]

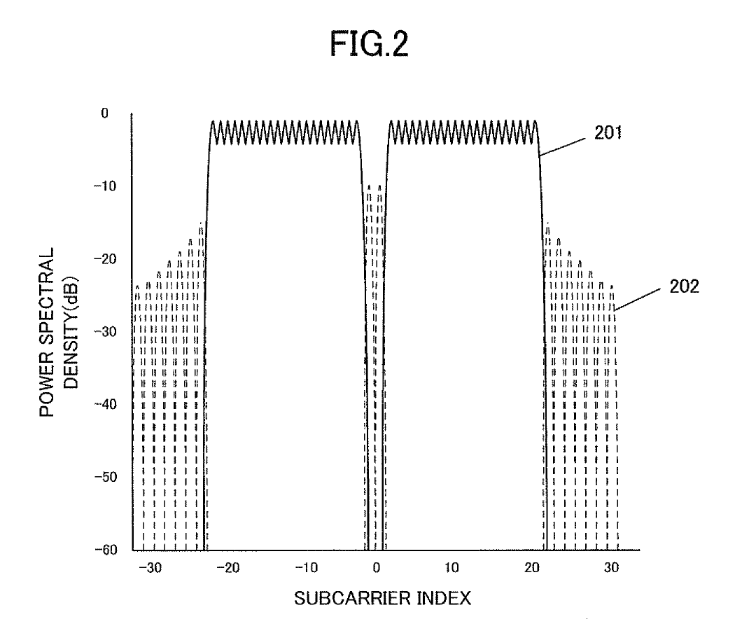

Before describing the master station device B in detail, band limitation through waveform shaping using a Gaussian pulse will be described. A Gaussian pulse is a pulse signal that uses a Gaussian function, and has a property whereby a duration and a bandwidth thereof are both limited. By multiplying the pulse signal by a carrier waveform, steep side lobe attenuation can be obtained relative to the frequency spectrum. FIG. 2 is a view comparing a frequency spectrum 202 (dotted lines) obtained when modulation is performed through OFDM with a frequency spectrum 201 (solid lines) obtained as a result of multiplication by a Gaussian pulse. During normal OFDM, a spectral dip of approximately 10 dB occurs, whereas when shaping is performed using a Gaussian pulse, attenuation of at least 60 dB can be obtained.

In other words, by performing band limitation through waveform shaping using a Gaussian pulse on a subcarrier used in OFDM, an effect on adjacent subcarriers or symbols can be minimized. It is known that when a standard deviation σ of power relative to a time direction of the Gaussian pulse used for the shaping is reduced, inter-symbol interference decreases, and when the standard deviation σ is increased, inter-carrier interference decreases. The standard deviation σ may take any value within a range for achieving the objects of the invention.

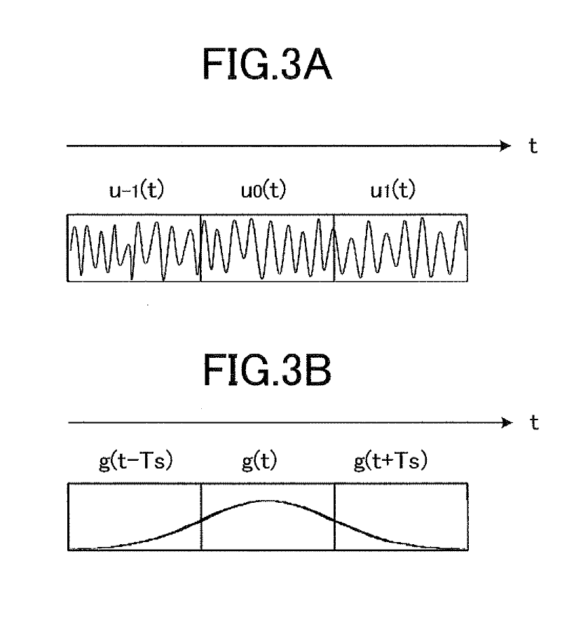

FIG. 3 is a view showing a band limitation method using a Gaussian function in detail. FIG. 3A shows three symbols of a signal subjected to inverse Fourier transform. In this example, band limitation is implemented on a section u₀(t) thereof. A target band-limited signal is obtained by multiplying a signal shown in FIG. 3B which is a Gaussian waveform by the signal shown in FIG. 3A using a following equation and adding together the three symbols. Note that g(t) denotes a Gaussian waveform, u(t) denotes an input signal, Ts denotes a symbol length, and a range of t is 0<t≦Ts. g(t−Ts)u₁(t+Ts)+g(t)u₀(t)+g (t+Ts)u₁(t−Ts)

In other words, a band-limited signal s(t) can be expressed by Mathematical Formula 1. Note that a truncation width of the Gaussian waveform is expressed by M×Ts, and in this example, M=3. k is an arbitrary integer.

$$s ( t + kTs ) = {\sum }_{i = \frac{- M + 1}{2}}^{\frac{M - 1}{2}} g ( t - iTs ) {u}_{k + i} ( t ) \qquad [ Math . 1 ]$$

When a plurality of terminals attempt to perform communication using a plurality of subcarriers through OFDMA, the spectra of adjacent subcarriers overlap, and therefore the carriers must be made orthogonal. Using this method, however, adjacent subcarriers do not interfere with each other, and therefore communication can be performed even in the absence of an orthogonal relationship. As a result, the need for symbol synchronization is eliminated. In other words, a plurality of terminals can perform communication using a plurality of symbol rates.

[Transmission Carrier Arrangement Method]

Next, a method of arranging transmission carriers will be described.

When either the master station device or a slave station device begins communication, frequencies to be used in the communication between the respective slave stations and the master station, or in other words a spectrum, are allocated by the spectrum control unit 101. More specifically, the spectrum control unit 101 determines frequencies to be allocated to communication between the multicarrier terminal and the master station device and a frequency to be allocated to communication between the single carrier terminal and the master station device. Information relating to the determined frequencies is transmitted to the multicarrier modulation signal generation unit 111. The multicarrier modulation signal generation unit 111 generates a modulation signal using the information. The multicarrier modulation signal generation unit 111 does not allocate data to a subcarrier which is determined as a subcarrier not to be used for multicarrier communication. In other words, the amplitude of a modulation output relating to this subcarrier is set at zero. The information relating to the frequencies determined by the spectrum control unit 101 is also transmitted to the single carrier modulation signal generation unit 112. The single carrier modulation signal generation unit 112 uses the information to generate a modulation signal.

In this embodiment, subcarriers determined as subcarriers not to be used for multicarrier communication will be referred to as null carriers. Subcarriers that are not used originally in the communication, such as DC subcarriers, will also be referred to as null carriers.

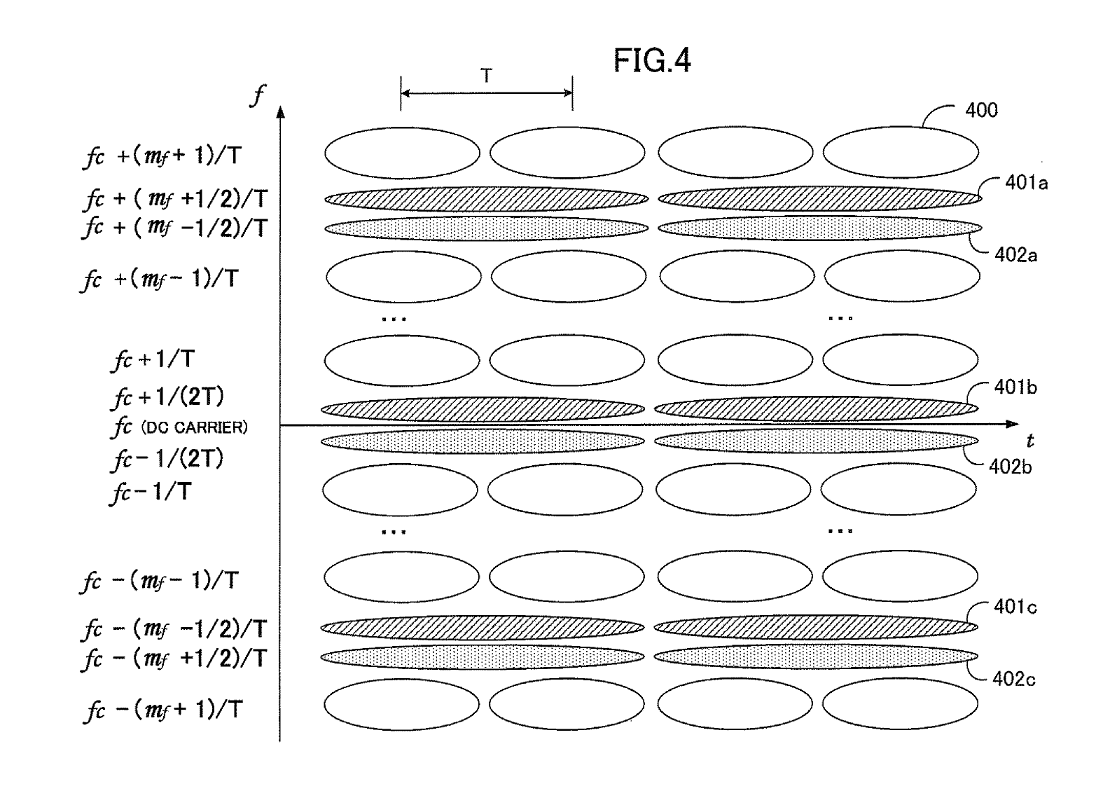

Frequency allocation may be performed as shown in FIG. 4, for example. In FIG. 4, an abscissa shows time and an ordinate shows frequency. Blank ellipses (reference numeral 400) indicate symbols of each subcarrier of a modulation signal exchanged between the master station device B and the multicarrier terminal TM. Shaded ellipses indicate symbols of each subcarrier of a modulation signal exchanged between the master station device B and the single carrier terminal TS.

Here, T is a symbol length (symbol period) of the multicarrier modulation signal (where seconds are used as a time unit; likewise hereafter). As will be described in detail below, the multicarrier modulation signal is generated by inverse fast Fourier transform (IFFT), and therefore a subcarrier interval is 1/T (where Hz is used as a frequency unit; likewise hereafter) or an integral multiple thereof. Here, the subcarrier interval is set at 1/T. Further, fc is a center frequency of the multicarrier modulation signal.

The frequencies of the subcarriers are provided by a formula fc+m/T. When m is an integer and a number of points of the IFFT (inverse Fourier transform) is N, a value satisfying −N/2≦m≦N/2−1 is obtained.

In this embodiment, communication is performed with the multicarrier terminal using subcarriers other than m=0, mf, and −mf. In other words, during multicarrier communication, the amplitude of the subcarriers m=0, mf, and −mf is set at zero. The spectra of the subcarriers not used by the multicarrier terminal are used for communication between the single carrier terminal and the master station device. In this example, an occupied bandwidth of the single carrier modulation signal is less than 1/(2 T). Therefore, the master station device 110 can perform single carrier communication with the two single carrier terminals TS1, TS2 using the band of a single null carrier. The single carrier terminal TS1 uses a spectrum of subcarriers fc+1/(2 T), fc+(mf+½)/T, and fc−(mf−½)/T. The single carrier terminal TS2 uses a spectrum of subcarriers fc−1/(2 T), fc+(mf−½)/T, and fc−(mf+½)/T.

The reason why it is possible here to modify the symbol rate between multicarrier communication and single carrier communication is that the modulation signal of the multicarrier communication is band-limited through waveform shaping using a Gaussian pulse, as described above, and therefore inter-carrier interference does not occur.

In FIG. 4, three carriers are used in each single carrier communication operation, but in this embodiment, each of these carriers transmits a single modulated by identical data. Hence, identical data are transmitted at three different frequencies, and therefore a frequency diversity effect can be obtained, enabling stable transmission. Thus, the frequencies of the subcarriers and the single carriers are arranged by the spectrum control unit such that the spectra thereof do not overlap.

Hereafter in this embodiment, TDD (Time Division Duplex) communication will be described. Further, a carrier generated by the multicarrier modulation signal generation unit 111 will be referred to as a high rate carrier, while a carrier generated by the single carrier modulation signal generation unit 112 will be referred to as a low rate carrier.

[High Rate Carrier Transmission Method]

Next, specific methods for realizing the carrier arrangement described above will be described.

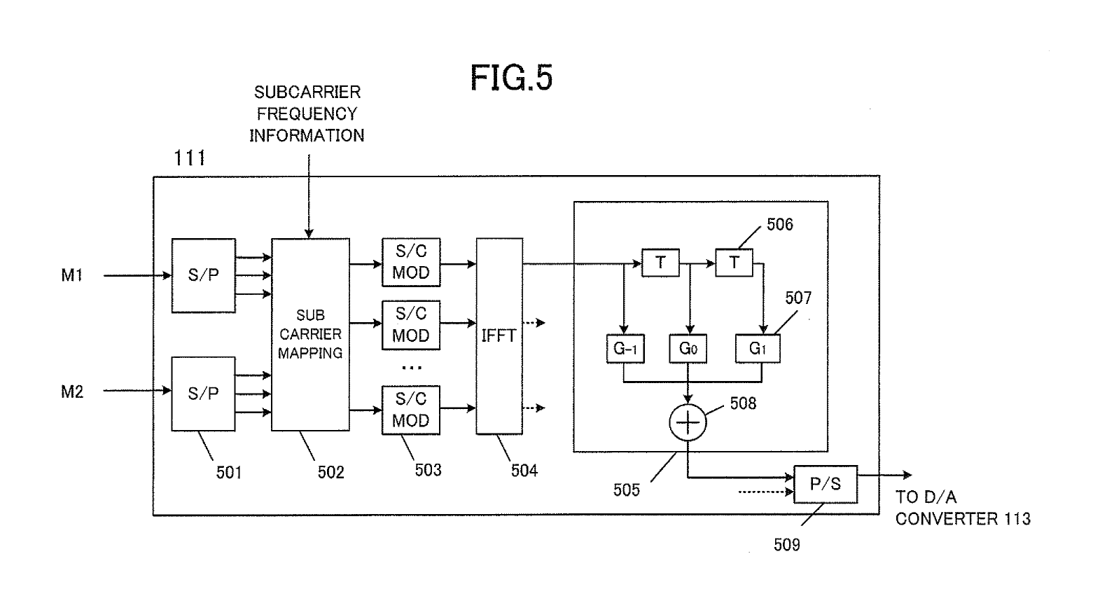

First, a high rate carrier transmission method will be described. FIG. 5 is a block diagram showing the multicarrier modulation signal generation unit 111. First, transmission data input with respect to each communication destination partner are subjected to serial/parallel conversion, symbol by symbol, in relation to each destination multicarrier terminal by a converter 501. Here, data M1 are data addressed to the multicarrier terminal TM1 and data M2 are data addressed to the multicarrier terminal TM2. A subcarrier mapping unit 502 then allocates an appropriate subcarrier group to each communication destination partner in accordance with the frequency information transmitted from the spectrum control unit 101. A sum of the allocated subcarriers is no greater than N. Here, N is the number of IFFT points, which is a number of a power of 2. Note that the subcarrier mapping unit 502 does not allocate data to subcarriers corresponding to fc₁ and fc₁±fd, fc₂ and fc₂±fd (definitions of alphabetic characters will be described below). In other words, the amplitude of the modulation output relating to these subcarriers is set at zero.

The signal divided into the N subcarriers is subjected to QPSK and QAM modulation, for example, by a modulator 503 disposed for each subcarrier, and converted into the multicarrier modulation signal by an IFFT converter 504 having the number of points N.

The configurations described heretofore are similar to those of a conventional wireless communication apparatus using OFDMA. Therefore, the multicarrier modulation signal is equivalent to a signal obtained by removing a guard interval (GI) from a conventional OFDM or OFDMA transmission signal.

Next, filter processing using a Gaussian pulse is implemented on each subcarrier by a band limitation unit 505. The band limitation unit 505 serves as convolution multiplication unit for multiplying one symbol of an impulse response of a filter that performs band limitation through waveform shaping using a Gaussian pulse. The band limitation unit 505 is constituted by two delay devices 506, three filters 507, and an adder 508. The delay devices 506 are registers or memories for delaying one symbol. Using u₀ in the drawing as a reference, u₋₁ denotes OFDM signal data of a previous symbol and u₁ denotes OFDM signal data of a following symbol. A Gaussian function is preferable as a filter characteristic of the filters 507, as described above, but another function, for example a root cosine roll-off filter or the like, may be used instead. In this embodiment, filter processing, or in other words truncation, is performed using data corresponding to three symbols, but the number of processed symbols may be increased. By increasing the number of processed symbols, interference between adjacent subcarriers and channels can be suppressed even further.

The multicarrier modulation signals generated as a result of the processing described above are added together by the adder 508. The other subcarriers are subjected to similar processing, whereupon the signals of all subcarriers are converted into serial data by a serial converter 509. The multicarrier modulation signal is then added to the modulation signal of the low rate carrier and transmitted via a D/A converter and a transmission circuit.

In high rate carrier transmission, the subcarriers are arranged using the method described above, whereupon the transmission signals are subjected to band limitation using a Gaussian function.

[Low Rate Carrier Transmission Method]

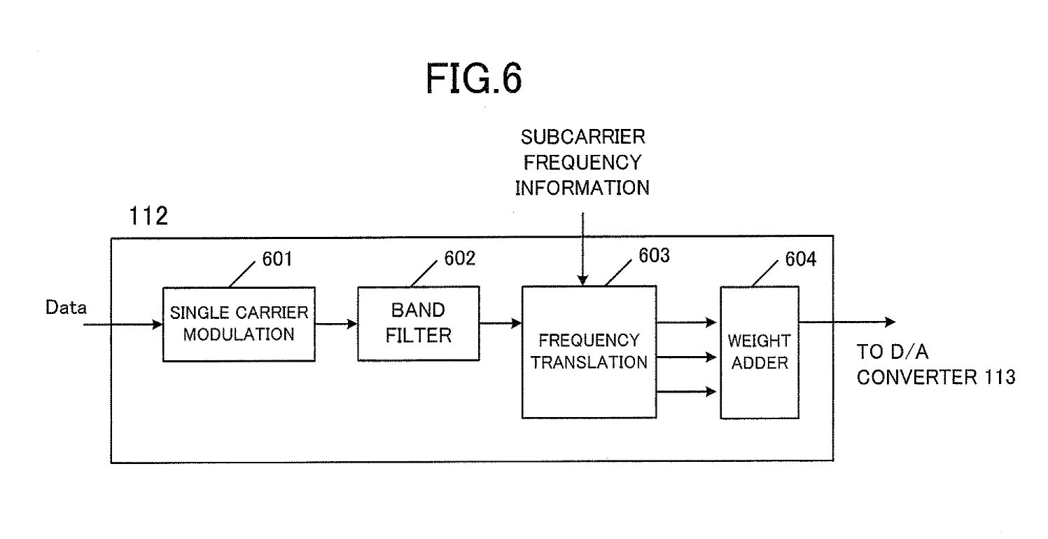

Next, a low rate carrier transmission method will be described. FIG. 6 is a view illustrating the single carrier modulation signal generation unit 112 in further detail. First, modulation signal generation relating to the single carrier terminal TS1 will be described.

A single carrier modulation unit 601 is unit for performing normal single carrier modulation such as QPSK or QAM on input communication data. Further, a band filter 602 is unit for performing band limitation using a Gaussian function, a root cosine roll-off filter, or the like, for example. Through the processing of these components, a similar base band single carrier modulation signal to a conventional signal is generated.

The generated single carrier modulation signal may have different modulation constants, such as the symbol rate, to the aforesaid high rate carrier, or in other words the multicarrier modulation signal. During transmission to a small, simply configured terminal such as a sensor terminal, for example, transmission at a low bit rate is often performed favorably. In this embodiment, the single carrier modulation signal has half the symbol rate of the high rate carrier, a symbol length 2T which is twice that of the high rate carrier, and an occupied bandwidth of approximately 1/(2 T), which is approximately half that of the high rate carrier.

Next, a frequency conversion unit 603 converts a modulation signal addressed to the single carrier terminal TS1 into three frequencies fc₁−fd, fc₁, fc₁+fd in the base band. Here, fc₁=fc+1/(2 T) and fd=mf/T. These three signals are obtained by implementing identical modulation on identical data, and therefore differ from each other only in the carrier frequency. A center frequency fc₁ and a shift width fd are controlled such that the three converted frequencies match the frequencies of the null carriers received from the spectrum control unit 101. In FIG. 4, fc₁, fc₁−fd, and fc₁+fd correspond to 401b, 401c, and 401a, respectively.

The three signals converted by the frequency conversion unit 603 are subjected to weighted addition by an adder 604. A weighting used in the addition is determined in accordance with a propagation loss (transmission loss) of the three frequencies, and may be set at a steadily larger value toward a frequency at which the propagation loss is small or such that the three signals are output at equal amplitudes. The weighting used in the addition is a complex number weighting that involves phase control. More specifically, the three signals are controlled to have an identical phase in an antenna input of the transmission destination terminal. A transmission characteristic of the transmission path may be measured by attaching a training signal to the top of the transmission data, as performed in many known wireless systems. Alternatively, the transmission characteristic may be estimated by receiving the phases and amplitudes of the transmission signals having the three frequencies in a reception circuit provided in the master station device B and comparing the received phases and amplitudes. Note that instead of performing weighted addition, the adder 604 may also select only the frequency exhibiting the smallest propagation loss and halt output of the signals corresponding to the other frequencies. In this case, the configuration and calculations are simplified.

A modulation signal is generated from the transmission data addressed to the single carrier terminal TS2 using a similar configuration. The modulation signal addressed to the single carrier terminal TS2 is converted into three frequencies fc₂−fd, fc₂, fc₂+fd in the base band and then output by a frequency conversion unit 603. Here, fc₂=fc −1/(2 T). In FIG. 4, fc₂, fc₂−fd, and fc₂+fd correspond to 402b, 402c, and 402a, respectively.

[High Rate Carrier Reception Method]

Next, a high rate carrier reception method will be described.

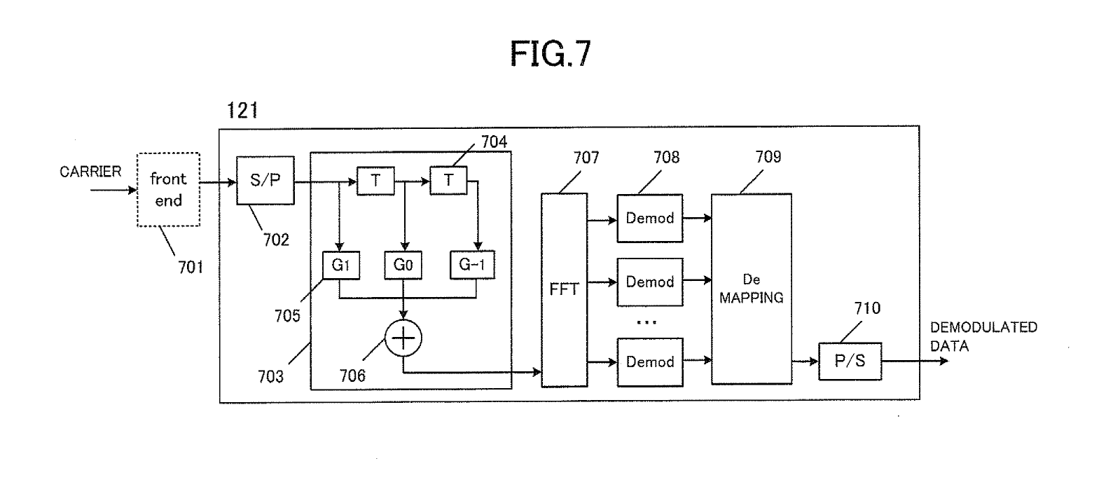

FIG. 7 is a view illustrating the multicarrier demodulation unit 121 in further detail. The received multicarrier signal is amplified by a front end unit 701 and converted into a base band signal. The base band signal is passed through an A/D converter and converted into a digital signal sequence thereby.

The converted digital signal sequence is converted into N samples of parallel data for each symbol by a serial/parallel converter 702. The parallel data are subjected to filter processing by a band limitation unit 703 configured identically to the band limitation unit 505 shown in FIG. 5. In the band limitation unit 703, filter processing is performed by a filter 705 via a delay memory 704 having the symbol length T. The filter processing implemented by the band limitation unit 703 is equivalent to applying a band pass filter in subcarrier units. As regards the filter characteristic of the filter 705, or in other words the impulse response, a matched filter corresponding to the filter characteristic of the filter 507 provided in the band limitation unit 505 may be used.

Note that a matched filter does not necessarily have to be used in the filter processing, and any filter having a pass bandwidth that is substantially equal to the subcarrier interval may be used. For example, when the filter characteristic is impulse response of a Gaussian function, inter-symbol interference is reduced by slightly shortening the Gaussian pulse width. Therefore, in a case where the delay spread is large, the characteristic may be improved by shortening the pulse width.

The filter-processed signal is converted into a modulation signal for each subcarrier by an FFT converter 707. Subsequent operations are identical to those performed in a conventional OFDM receiver or OFDMA receiver. The signals are demodulated by a demodulation unit 708, and converted into the original data by a demapping unit 709 and a parallel/serial conversion unit 710 that perform opposite processing to the subcarrier mapping of the transmission unit.

[Low Rate Carrier Reception Method]

The configuration of the single carrier demodulation unit 122 shown in FIG. 1 (i.e. a low rate carrier reception method) is identical to signal processing performed by a conventional single carrier receiver for receiving the three frequencies fc₁ and fc₁±fd and diversity-synthesizing demodulation outputs to obtain reception data. Therefore, description of the single carrier demodulation unit 122 has been omitted.

[Multicarrier Terminal]

The multicarrier terminal TM is formed by omitting functions relating to single carrier transmission and reception from the master station device B, and therefore description of the multicarrier terminal TM has been omitted.

[Low Rate Carrier Dedicated Terminal]

The description heretofore has focused mainly on transmission and reception methods used by the master station device B. Next, transmission and reception methods used by a low rate carrier dedicated terminal will be described.

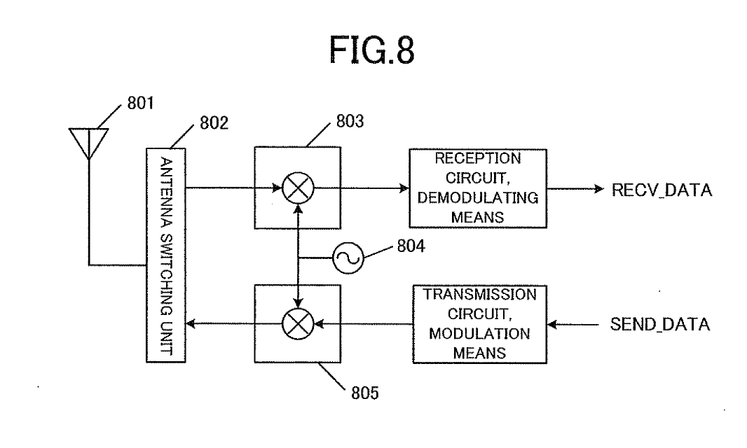

FIG. 8 is a view illustrating the configuration of the single carrier terminal TS. A reception circuit and demodulating unit in FIG. 8 receive a carrier frequency fc₁ or fc₂, similarly to a conventional single carrier receiver. Note that fc₁ and fc₂ are center wavelengths (fc+1/(2 T) or fc −1/(2 T)) of low rate carriers transmitted by the master station device B. It is assumed in this embodiment that the single carrier terminal TS1 receives the carrier frequency fc₁ and the single carrier terminal TS2 receives the carrier frequency fc₂, and the frequency of TS1 will be described as an example.

A reception signal from an antenna 801 is input into an antenna switching unit 802 constituted by an identical duplexer to the antenna switching unit 102, and into a reception circuit via a mixer 803 serving as a frequency conversion circuit. In the mixer 803, the reception signal is intermixed with a local signal having a frequency fd, which is generated by a local oscillator 804. The mixer may take one of several configurations depending on the circuit, but the mixer used here is of a type in which a sum of and a difference between an input signal frequency and a local signal frequency, as well as an input signal, appear in an output. The mixer 803 may be a source injection mixer that adds the input signal and the local signal to an input of a source grounded FET (Field Effect Transistor) amplification circuit, or a circuit such as a Gilbert cell mixer that slightly unbalances a differential input relative to an input port of a balanced modulation circuit, for example. These mixers are highly typical high frequency circuits.

It is assumed here that the mixer 803 inputs the three frequencies fc₁ and fc₁±fd. The sum of and difference between the input signal frequency and the local signal frequency, and the input signal, appear in the output from the mixer. More specifically, an input component of fc₁, an input component of fc₁+fd, and an input component of fc₁−fd are converted into frequency components fc₁ and fc₁±fd, frequency components fc₁, fc₁+fd and fc₁+2fd, and frequency components fc₁, fc₁−fd and fc₁−2fd, respectively, and appear thus at an output port. In other words, the three reception signals respectively having the frequencies fc₁ and fc₁±fd are all converted into the frequency fc₁.

A reception frequency of the reception circuit described above is set at fc₁. In other words, other frequency components are removed such that signals having the three aforesaid frequency components are received after being superposed and added together about fc₁. As described above, in the single carrier modulation signal generation unit 112 of the master station device B, the three frequency components are transmitted after being phase-controlled to identical phases. Therefore, the signals reinforce each other such that frequency diversity reception corresponding to maximum ratio combining or equal gain combining is realized. The aforesaid phase control is performed on the master station device B side, and therefore diversity reception can be performed simply by adding the mixer circuit and the local oscillator to the normal single carrier reception circuit on the terminal side.

Note that in the master station device B, the transmission frequency of the low rate carrier may be set at fc₂ or the like instead of fc₁, but even when the carrier frequency is different, the reception logic of the single carrier terminal of course remains the same.

This embodiment relates to a TDD wireless system that performs transmission and reception at a constant frequency through time division. However, an FDD (Frequency Division. Duplex) system that performs transmission and reception simultaneously at different frequencies may be used instead. In this case, the antenna switching unit 102 of FIG. 1 and the antenna switching unit 802 of FIG. 8 are constituted by antenna sharing devices (duplexers).

Next, a method of transmitting a low rate carrier using the single carrier terminal TS configured as shown in FIG. 8 will be described. Modulation unit and a transmission circuit are similar to those of a transmission device provided in a conventional single carrier radio, and a carrier frequency fc₁ or fc₂ is transmitted. A mixer 805 serving as a frequency conversion circuit is connected to an output of the transmission circuit. The mixer 805 operates identically to the mixer 803 described in the reception operation. Hence, the three frequency components fc₁ and fc₁±fd or fc₂ and fc₂±fd are output respectively at an identical phase from an output of the mixer 805 and transmitted from the antenna to the master station device B. In other words, a similar frequency diversity effect to that of the reception operation can be obtained by adding an identical mixer circuit to the transmission side.

### Second Embodiment

In a second embodiment, communication through MIMO is performed using the master station device B and the single carrier terminals TS1 and TS2.

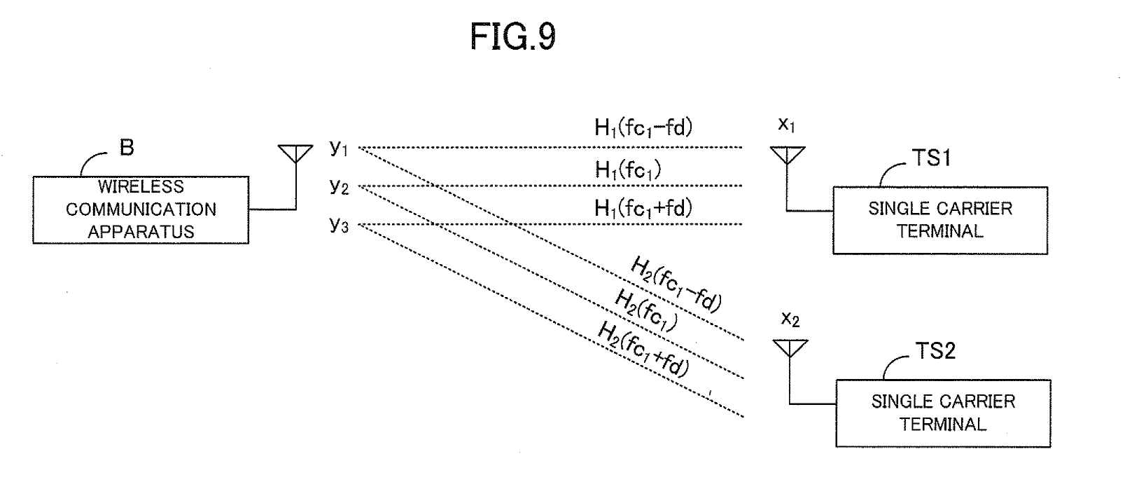

FIG. 9 is a view illustrating a relationship between a wireless communication apparatus and terminals according to the second embodiment. In this embodiment, communication is performed using the master station device B and the two single carrier terminals TS1, TS2. Here, the single carrier terminals will be referred to as slave station devices.

The slave station devices TS1 and TS2 are configured identically to those described in the first embodiment. In this embodiment, however, a case in which a common frequency is allocated to the slave station devices TS1 and TS2 such that communication is performed using an identical spectrum of fc₁ and fc₁±fd will be described. In FIG. 9, H₁(f), H₂ (f) respectively represent transfer functions of a transmission path (a propagation path) from the slave station devices TS1, TS2 to the master station device at a frequency f.

x₁, x₂ respectively represent base band signals of the transmission signals in the slave station devices TS1, TS2, and y₁, y₂, y₃ respectively represent base band signals of the reception signals on the spectrum of the frequencies fc₁ and fc₁ fd, fc₁−fd in the master station device. Note that the base band signals of the transmission signals in the terminals TS1, TS2 are shared on a spectrum of any of the frequencies fc₁ and fc₁±fd, as is evident from the configuration shown in FIG. 8.

An operation of the communication system configured as described above will now be described. A relationship illustrated in Mathematical Formula 2 exists between the transmission signals x₁, x₂ from the slave station devices TS1 and TS2 and the reception signals y₃ y₂, y₃ in the master station device.

$$\begin{matrix}( \begin{matrix}{y}_{1} \\ {y}_{2} \\ {y}_{3}\end{matrix} ) = ( \begin{matrix}{H}_{1} ( {fc}_{1} + fd ) & {H}_{2} ( {fc}_{1} + fd ) \\ {H}_{1} ( {fc}_{1} ) & {H}_{2} ( {fc}_{1} ) \\ {H}_{1} ( {fc}_{1} - fd ) & {H}_{2} ( {fc}_{1} - fd )\end{matrix} ) ( \begin{matrix}{x}_{1} \\ {x}_{2}\end{matrix} ) & [ Math . 2 ] \\ y = Hx & [ Math . 3 ]\end{matrix}$$

This is rewritten as shown in Mathematical Formula 3. Here, a column vector of x₁, x₂ is replaced by x, a column vector of y₁, y₂, y₃ is replaced by y, and the three-row, two-column matrix on the right side of Mathematical Formula 2 is replaced by H. The reception signals received by the master station device are signals in which x₁ and x₂ are intermixed, and therefore, in this state, the signals interfere with each other and cannot be received. Hence, the master station device estimates H and multiplies a generalized inverse matrix H⁺ of H from the left of both sides, as shown in Mathematical Formula 4, such that H⁺H takes a value close to a two-row, two-column unit matrix. By performing weighted addition on the three reception signals y using the generalized inverse matrix of H, x₂ and x₂ are obtained separately. In other words, H is determined such that a ratio between a power of a desired signal and a power of an undesired signal, or in other words an interference signal, is minimized. This signal processing is known as zero forcing.

\hat{x}=H⁺Hx=H⁺y [Math. 4]

This technique of separating and demodulating a signal from a plurality of signals superposed on a plurality of transmission paths is known as MIMO, and several signal processing systems other than zero forcing, such as MMSE (Minimum Mean Squared Error), are known. When MMSE is used, the weighting of the weighted addition may be controlled such that a ratio of the desired signal power to a sum of the interference signal power and a noise signal power is maximized. In place of zero forcing and MMSE, any signal processing system with which a multiplex transmission effect is obtained, for example another algorithm such as MLD (Maximum Likelihood Detection), may be used. These signal processing systems are disclosed in Standard Technical Collection “MIMO (Multi Input Multi Output) Related Technology” or the like, published on the website of the Japan Patent Office, for example.

The MIMO according to this embodiment differs from conventional MIMO on the following points. In conventional MIMO communication, spatial multiplexing transmission is performed at a constant frequency using a plurality of terminals serving as slave station devices and a plurality of antennae provided in a master station device. In the second embodiment, on the other hand, a MIMO transmission path can be formed from a single antenna using a plurality of terminals serving as slave station devices and a plurality of frequencies.

Next, a case of transmission from the master station device to the slave station devices TS1 and TS2 will be described. Likewise during opposite direction communication, two signals having different terminal addresses can be transmitted at identical frequencies, as described above. This case will be described below with reference to Mathematical Formula 5. Here, y_{d1}, y_{d2} respectively represent base band signals of the reception signals received in the slave station devices TS1, TS2, while x_{d1}, x_{d2}, x_{d3} respectively represent base band signals of transmission signals on the spectrum of the frequencies fc₁ and fc₁+fd, fc₁−fd of the master station device.

$$\begin{matrix}( \begin{matrix}{y}_{d 1} \\ {y}_{ d 2}\end{matrix} ) = {H}^{T} ( \begin{matrix}{x}_{d 1} \\ {x}_{d 2} \\ {x}_{d 3}\end{matrix} ) & [ Math . 5 ] \\ {y}_{d} = {H}^{T} {x}_{d} & [ Math . 6 ]\end{matrix}$$

H^{T} is a transposed matrix of H, and Mathematical Formula 6 is obtained by rewriting y_{d1}, y_{d2} and x_{d1}, x_{d2}, x_{d3} respectively in the form of column vectors. Further, by setting s₁, s₂ as the base band signals of the transmission signals heading toward the respective slave station devices TS1, TS2 and inserting a row vector x_{d} in Mathematical Formula 7, a relationship of Mathematical Formula 8 is obtained.

$$\begin{matrix}{x}_{d} = {( {H}^{+} )}^{T} ( \begin{matrix}{S}_{1} \\ {S}_{2}\end{matrix} ) & [ Math . 7 ] \\ {y}_{d} = {{H}^{T} ( {H}^{+} )}^{T} ( \begin{matrix}{S}_{1} \\ {S}_{2}\end{matrix} ) = \begin{matrix}( {H}^{+} & {H )}^{T} ( \begin{matrix}{S}_{1} \\ {S}_{2}\end{matrix} )\end{matrix} & [ Math . 8 ]\end{matrix}$$

In other words, by generating and transmitting x_{d} through the signal processing of this formula, it is possible to receive only one of s₁ and s₂ dominantly on the slave station device side. In this case, there is no particular need to perform signal separation calculations in the slave station devices TS1, TS2, and therefore the operation can be performed by the frequency conversion circuit shown in FIG. 8.

Hence, according to this embodiment, complicated signal processing is not required in the terminal device, and therefore a master station device, a slave station device, and a communication system using the master and slave station devices that is suitable for use with small sensor terminals or the like can be provided.

### Modified Examples

The embodiments described above are merely examples, and the present invention may be subjected to appropriate modifications within a scope that does not depart from the spirit thereof. For example, three null carriers were described in the embodiments, but another group of null carriers may be provided in a position even further removed from the center frequency such that a total of five null carriers exist. Further, frequency diversity need not be used, and instead, separate communication may be performed using a plurality of low rate carriers.

Furthermore, the symbol rate used during single carrier communication does not have to be half the symbol rate used during multicarrier communication, and may be set as desired.

Moreover, in the above description, transmission and reception processing is performed between the master station device and the multicarrier terminal and between the master station device and the single carrier terminal, but single direction communication may be performed in one or both cases. For example, a configuration in which transmission and reception is performed between the master station device and the multicarrier terminal but only transmission is performed from the single carrier terminal to the master station device may be used. The advantageous effects described above can be obtained likewise in this case.

Further, the spatial multiplexing transmission of the second embodiment may be performed using only the master station device and the single carrier terminal, i.e. without using a multicarrier terminal. Likewise in this case, a MIMO transmission path can be formed from a single antenna using a plurality of terminals serving as slave station devices and a plurality of frequencies.

Furthermore, in the above description, an example in which a frequency diversity effect and a MIMO effect are obtained in the single carrier terminal by setting the input frequency of the frequency converter (the mixer) as fc₁ and having the frequency converter output the frequencies fc₁+fd, fc₁, fc₁−fd was described. However, similar diversity and MIMO effects can be obtained with a configuration in which the mixer of the single carrier terminal outputs only two frequencies fc₁+fd and fc₁−fd relative to the input frequency fc₁.

Moreover, in the examples described in the embodiments, a single master station device communicates with the slave station devices, but by performing control to ensure that the frequencies of the used carriers do not overlap, a combination of a plurality of master station devices and slave station devices may be arranged within a mutual communication range.

What is claimed is:

1. A wireless communication apparatus comprising:
first communication unit configured to perform at least one of transmission and reception by using a multicarrier signal constituted by a plurality of subcarriers shaped by a band-limited pulse waveform; and
second communication unit configured to perform at least one of transmission and reception by using a signal having a different modulation format or modulation constant from said signal of said first communication unit,
wherein said first communication unit configured to perform communication without using at least one of said plurality of subcarriers, and
said second communication unit configured to perform communication using a band of said subcarrier not used by said first communication unit.

2. The wireless communication apparatus according to claim 1, wherein a symbol of said subcarrier used by said first communication unit is non-synchronous with a symbol of a carrier used by said second communication unit.

3. The wireless communication apparatus according to claim 1, wherein said first communication unit configured to perform communication without using at least two of said plurality of subcarriers, and
said second communication unit:
configured to communicate identical signals infrequency bands of said subcarriers not used for communication by said first communication unit; and
either configured to transmit said signals in said respective frequency bands after weighting said signals or configured to select and transmit a signal in any of said frequency bands.

4. The wireless communication apparatus according to claim 3, wherein said second communication unit configured to transmit said signals in said plurality of frequency bands after weighting said signals such that said signals in said plurality of frequency bands have an identical phase in an antenna input of a transmission destination terminal.

5. The wireless communication apparatus according to claim 3, wherein said second communication unit configured to transmit said signals in three frequency bands fc+fd, fc, fc−fd having equal frequency intervals.

6. The wireless communication apparatus according to claim 1, wherein said first communication unit configured to perform communication without using at least two of said plurality of subcarriers,
said second communication unit configured to perform transmission to a plurality of terminals by using transmission signals in frequency bands of said subcarriers not used for communication by said first communication unit, and
said transmission signals of said respective frequency bands are determined by subjecting data addressed to a plurality of terminals to weighted synthesis on the basis of a propagation path characteristic.

7. The wireless communication apparatus according to claim 6, wherein said second communication unit configured to transmit said data addressed to said plurality of terminals after weighting said data such that said data are received dominantly in antenna inputs of said terminals.

8. The wireless communication apparatus according to claim 1, wherein said first communication unit configured to perform communication without using at least two of said plurality of subcarriers,
said second communication unit configured to receive signals by using frequency bands of said subcarriers not used for communication by said first communication unit,
signals including identical data are transmitted from a transmission source in said respective frequency bands, and
said second communication unit either configured to receive said signals in said respective frequency bands after weighting said signals or configured to select and transmit a signal in any of said frequency bands.

9. The wireless communication apparatus according to claim 1, wherein said first communication unit configured to perform communication without using at least two of said plurality of subcarriers,
said second communication unit configured to receive signals from a plurality of terminals by using frequency bands of said subcarriers not used for communication by said first communication unit,
said plurality of terminals respectively transmit signals in a plurality of frequency bands, and
said signals transmitted from said respective terminals are extracted by subjecting said signals received in said respective frequency bands to weighted synthesis on the basis of a propagation path characteristic.

10. A wireless communication apparatus comprising:
reception unit configured to receive signals in a plurality of frequency bands, transmitted from said second communication unit of the wireless communication apparatus according to claim 3; and
frequency conversion unit configured to frequency-convert an input signal,
wherein said signals in said plurality of frequency bands received by said reception unit are converted into a common frequency band by said frequency conversion unit.

11. A wireless communication apparatus comprising:
reception unit configured to receive signals in frequency bands fc+fd, fc, fc−fd, transmitted from said second communication unit of the wireless communication apparatus according to claim 5; and
frequency conversion unit configured to frequency-convert an input signal and outputting a signal obtained by superposing said input signal, a signal obtained by frequency-converting said input signal by a frequency +fd, and a signal obtained by frequency-converting said input signal by a frequency −fd,
wherein said reception unit configured to superpose and adds said signals in said frequency bands fc+fd, fc, fc−fd to said frequency band fc by unit of said frequency conversion unit.
